(19) United States
(12) Patent Application Publication
(10) Pub. No.: US 2014/0324549 A1
(43) Pub. Date: Oct. 30, 2014

(54) PRICE ASSURANCE ENGINE

(71) Applicants: Matthew J. CHELAP, Saint Paul, MN (US); Clauss-Peter HAHN, Burgstaedt (DE)

(72) Inventors: Matthew J. CHELAP, Saint Paul, MN (US); Clauss-Peter HAHN, Burgstaedt (DE)

(21) Appl. No.: 14/265,970

(22) Filed: Apr. 30, 2014

Related U.S. Application Data
(60) Provisional application No. 61/817,450, filed on Apr. 30, 2013.

(51) Int. Cl. G06Q 30/02

(52) U.S. Cl. CPC G06Q 30/0206
USPC 705/7.35

(57) ABSTRACT

A system and method that establishes and maintains pricing for participating vendors and an authorized buyer using a metadata-software application that provides a useful history of purchases and discounts for audit records. The system provides base prices and price discounts based on the average actual sale price of an item or service over a period of time. The terms of the averaging procedure, and the mathematical algorithms utilized to calculate “average” can differ from contract to contract and are defined in a way that buyers perceive as fair, reasonable and transparent, and vendors find acceptable. Using the system will confirm that the price paid for a commercial good or service is market-based, and that terms and conditions of the sale leverage volume-buying power, ensuring the best possible price and the best possible terms for all commercial transactions in today's marketplace.

### FIELD OF THE INVENTION

The invention relates to a system and method for establishing and maintaining pricing for vendors participating in the public or private sector to provide products and services to an authorized buyer.

### DESCRIPTION OF RELATED ART

Those in the public sector, including commercial buyers and procurement professionals, seek assurances that the prices they pay for commercial goods and services are “fair, reasonable and transparent.” This assurance is both difficult and time consuming for vendors or sellers to achieve, however it is necessary to demonstrate the basis for which a price is presented in order to win business from authorized buyers.

The current business-to-business electronic commerce market has been growing rapidly, with the business-to-government electronic commerce market growing at a slower rate because of the unique requirements of the government to negotiate, verify and audit commercial pricing, sales history, and discount practices. Procurement professionals seek assurances that the prices they pay for commercial products and services, or “items,” are “fair, reasonable and transparent.” To achieve this, the public sector, especially, seeks contractual guarantees concerning pricing. However, it can be a struggle to find objective and verifiable standards for pricing practices that can be agreed upon and implemented in contractual terms and conditions, and verified through post-award audit-compliance mechanisms.

The nature of internet-business trading is currently much more complex and orders of magnitude faster than current manually intensive government-contract negotiation, contract formation, contract-administration and audit and reasonable assurance business processes. As a result, internet-based e-commerce has not yet been quickly and economically adapted for the business-to-government vertical market.

In order to achieve the potential of on-line commerce, a number of technical business practices and cultural hurdles must be overcome. That means making sense of the dizzying number and complexity of discount structures, channel partnerships, and pricing schemes in the business-to-business and business-to-government marketplaces that make doing business burdensome for both buyers and sellers.

In the marketplace overall, buyers (primarily financial officers and procurement professionals from large businesses and the public sector) and their customers (lines of business and ordering agencies) seek assurances that the price they pay for an item is competitive, market-based, and correctly reflects the buyer's aggregate buying power.

However, it is common practice for an identical item to be sold at entirely different prices to different purchasers by the same vendor on the same day. For example, a large distributor of electrical wire and cable may sell hundreds of thousands of a given product to thousands of different “buyers” in a single day, with each customer paying an entirely different price. Reasons for this include the nature of the customer (commercial vs. nonprofit vs. consumer, etc.), quantity discounts, differing terms in negotiated contracts, distribution, time of quote and sale, preferences for small business, channel strategy, and others.

According, buyers and buyer brokers working with vendors or sellers desire a guarantee that the buyer is receiving fair, reasonable and transparent pricing, with an assurance that the pricing is determined by standards. One example of such an authorized buyer is the U.S. General Services Administration (GSA) which purchases or authorizes purchases of products and services from hundreds to thousands of vendors to member government entities according to a pricing schedule (GSA Schedule). Other examples are purchasing organizations that provide products and services for large Global 50 companies.

### BRIEF SUMMARY OF THE INVENTION

The system and method for establishing and maintaining pricing for vendors participating in the public or private sector to provide products and services to an authorized buyer permits vendors to quote prices for products and services being offered, and also allows for adjustments to the pricing in an automated real-time environment.

The system and method allows commercial and government-procurement professionals to use cost-effective “horizontal” time-based and market-based information to determine reasonable prices for every product or service being purchased from such vendors.

The system and method for establishing and maintaining pricing for participating vendors enables a wide range of standard commercially available goods and services to be priced, where the quoted price and/or discount is based on a statistical average of selected sales or samples of selected buyers and transactions over a defined period of time.

The system and method for establishing and maintaining pricing for participating vendors enables the organization of ongoing routine purchases of standard commercial products and services under standard terms and conditions. Also, crucial business processes necessary to conduct price negotiations are able to be facilitated.

Further, the system and method for establishing and maintaining pricing enables participating vendors and the authorized buyer or broker to negotiate and execute contract formation, perform ongoing contract administration including updating with contract changes, and provide audit, reasonable assurance and risk-management associated with the ongoing negotiation and purchase of standard commercial products and services.

### BRIEF DESCRIPTION OF THE DRAWINGS

FIG. 1 shows a system and process flow of executing the method of the invention according an embodiment.

FIG. 2 shows a system and process flow diagram of a metadata scanning embodiment of the invention used with the system of FIG. 1.

### DESCRIPTION OF THE PREFERRED EMBODIMENT

The system and method for establishing and maintaining pricing for participating vendors and an authorized buyer is available for implementation using commercially available hardware, such as computers or terminals, servers and database that communicate to provide automated-statistical analysis and metadata-management. Participating vendors (“sellers”) quote prices and provide discounts for a wide range of goods and services to customers (“buyers”), including a broker for a number of buyers, in which the quoted base price (a best price or best price that has been discounted by the seller) is based on a statistical measure (an “average”) of selected sales over some earlier period of time.

An item's price is calculated using a series of mathematical algorithms that queries seller data. The system and method then uses this data to determine the average actual sale price of an item (or class of items) over a specified period of time, and generates a price for that buyer. Quoted prices are verifiable and auditable, as the chosen average may be recomputed based on underlying data, or verified with statistical sampling techniques and through ongoing automated metadata management.

The system and method also facilitates transactions and greater price transparency by providing authorized buyers with a direct interface to suppliers via the Internet and electronic-trading networks, where they can access approved and pre-negotiated prices for even greater added value. This allows buyers, including a broker for a large number of buyers, to leverage for themselves the investment in information technology that various participating suppliers have made available in their supply management and logistics-information systems.

The system and method for establishing and maintaining pricing provides both buyers and sellers with the benefits, including the elimination of lengthy, manually-intensive, and sometimes error-prone or inconsistent sourcing, negotiation, approval and procurement cycles for acquisition of commercial products and services. Additionally, the system is able to provide additional levels of security for individual transactions, as well as sensitive data on sales history. This facilitates the use of e-commerce and electronic-trading networks operated by both the public and private sector, which would provide buyers with timely, up-to-date product and service information (price, availability, configurations, ordering, shipping and delivery tracking), current internet-based industry-leading customer self-service and customer care and better return on both buyer and seller IT investments in e-commerce

Additionally, The system and method for establishing and maintaining pricing for participating vendors reduces audit risk in which the buyer or broker audits the vendor's pricing history over a period of time to obtain assurance of “best price” among sales and contract data to the vendor's customers, which improves audit coverage and productivity,

The system and method for establishing and maintaining pricing provides up-do-date sales and pricing data for detailed price analysis (for post-contract award re-negotiation) and new branding and customer-loyalty programs, makes most-current prices available that result from rapid price reductions or changes in the marketplace, and expands the use of authorized commercial and government credit cards to achieve savings in lower transaction-processing costs.

The system and method for establishing and maintaining pricing represents transformational technology that allows any major buying organization to establish a new line of business and a radically new business model that allows buyers to establish an automated database as a clearinghouse and price exchange to calculate prices for sellers of commercial products and services. Price negotiations and contract formation, which now take weeks, months, or even years, could be transformed into a real-time, on-line trading environment.

Vendors participating in the public or private sector to provide products and services to an authorized buyer will quote prices and/or price discounts based on the average actual sales price of an item (or class of items or services) over some determined period of time. The terms of the averaging procedure can differ from contract to contract (between different vendors and the buyer), and among orders or individual transactions, but all averaging procedures are able to be clearly and objectively defined by maintaining a database of sales history for each vendor and for the histories of all vendors participating in the system. Also, the sales pricing is made audit-worthy through calculations via mathematical algorithms, combined with automated metadata-management processes. Further, the price averaging is able to be clearly and objectively defined in a way the buyer perceives as fair, and the vendor finds acceptable.

Commercial suppliers and vendors are also free to conduct business as they wish, which means they can offer special prices to the occasional customer without concern that this practice may violate volume-purchased agreements offered to large purchasing organizations, such as Global 50 companies and the Federal Government's leading acquisition organization, the US General Services Administration.

Overall, real-time implementation of the system and method of the invention is particularly well suited to electronic commerce because of its ability to offer final pricing (inclusive of all discounts) at prices that are calculated and updated in real-time.

The system and method provides vendors and a buyer(s) to benefit from rapid price reductions or price changes that are influenced by, for example, swings in semiconductor prices (e.g. Moore's Law), Increases or decreases in the price of commodities or raw materials, new-product release cycles and new-information technology and other business consulting and offerings of professional services.

The system and method for establishing and maintaining pricing for participating vendors and an authorized buyer automates price and discount quotations where the price quoted is an appropriate statistical combination of prior sales prices or discounts. Such a statistical combination is called an “average”.

The system and method would be implemented by the buyer or buyer's representative, such as a third party organization. The vendor submits information in confidentiality to the buyer of a vendor's prior sales data (or provides access to such data), in the form of itemized sales records. Each record identifies a variety of characteristics of the transaction that might include:
the item sold (by unique stock code or other identifier)
the class of item
quantity sold
total price
unit price
list price or original manufacturer's price
discount allowed and/or markup over manufacturer's price
buyer identity (by name or appropriate identification code)
class of buyer (public sector, consumer, large business, etc.)
sales channel (large, small, or disadvantaged business)
sale location or region

The sales records can be made available to the system and method of the invention in various ways, including from database files, spreadsheet files, information stored in the “Cloud,” or directly communicated to the system via the internet or electronic file transmission. Sales data can be updated at scheduled intervals (nightly, weekly), or in “real-time,” as sales occur, or when invoices are produced or payment is received.

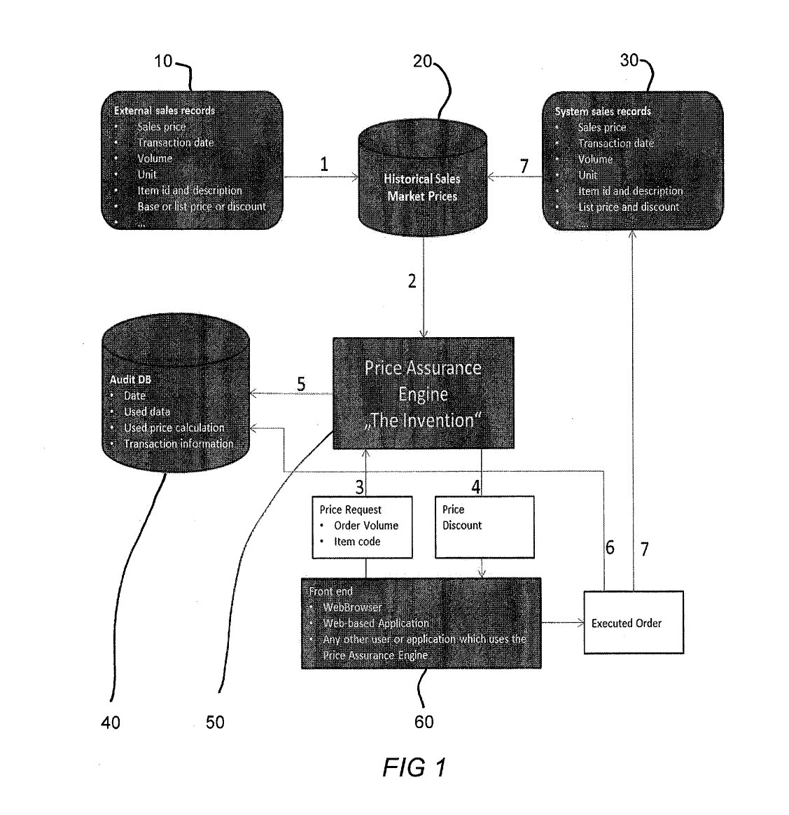

FIG. 1 shows a system and process flow of executing the method of the invention according an embodiment in which the components of the system are shown as processors, servers, computers or terminals connected to communicate with each other through the Internet.

External sales records are maintained in digital form, such as in a database 10 maintained by a vendor or a supplier or broker, including access to the Internet through a processor or interface communicating with the database. An Initial (or update) load process (1) of the system and method's “knowledge data base” 20 is executed to load or update the database 20 with current market prices in a process, known for example as an ETL process.

The sources for the historical information in database 20 are current Excel spreadsheets, databases, and other available information, including from executed sales stored in database 30 (step 7). Information about current market prices will be gathered from providers, or by analyzing the Internet's marketplaces. Access to the Internet may be through a processor as part of the database or server 20 or by receiving the information by connection through an interface or through database 10.

The information is accessed by a computer or server and processor 50 (step 2) to calculate an average from which fair and transparent prices are calculated by an algorithm supported by software (stored in storage available to the processor 50) that is executed by processor 50.

The calculation will be executed in response to the sending of a request (step 3) of the user of the system, via a Web-based User Interface provided by a terminal or computer 60 of the user or buyer, for example. A base price and the discount (or final price) is then delivered in step (4). Information about the price calculation result delivered in step (4) will be stored as an Audit record. In Audit database or server 40, which may be a computer connected through the Internet. Information about the executed order and the reference to the used price calculation, also, will be stored as an Audit record in storage 40. In case of a sales transaction without using the system of FIG. 1, audit information may be entered by the vendor about the reason for not using the system and the transaction information will be stored accordingly for reference in the database 40. Additionally, information about the executed order will be stored in the system's knowledge database. 20.

In further detail, the system uses the data to compute average sale price(s) for the item. Averages can include or exclude specified prior sales, or categories of prior sales, based on their characteristics or any other “business rules” programmed into the system software. For example, a transaction might:
include or exclude sales of particular purchases or a class of purchasers, including small businesses but excluding public sector sales, for example
exclude certain individual sales, such as all itemized sales from, say, invoice #12345
exclude sales from certain geographic areas, sales channels or class of customer
exclude sales based on quantity, both below and above a given threshold
exclude prior sales by the customer making the price request

In addition, the system is configured to be able to weigh information, for example, giving certain sales less or more significance in determining averages. Sales conducted 6 to 12 months ago, for example, might be given half the weight of those completed less than 6 months ago. Such data might include seasonal and local dependencies, quantity, delivery terms and conditions (place and time) and sales channels (small or large business), or other characteristics of a transaction. The system is also able to customize the quotation based on prior sales that have different terms.

Based on the sales records, outlined above, the system conducts a price request that asks for a quote for a specified quantity of a particular product for a specified customer, and responds by quoting the selected average price per unit, as well as an extended price for the total order, or multiples of the same items, and includes a time/date stamp indicating when the quotation was produced and an expiration date indicating how long the price assurance will be honored.

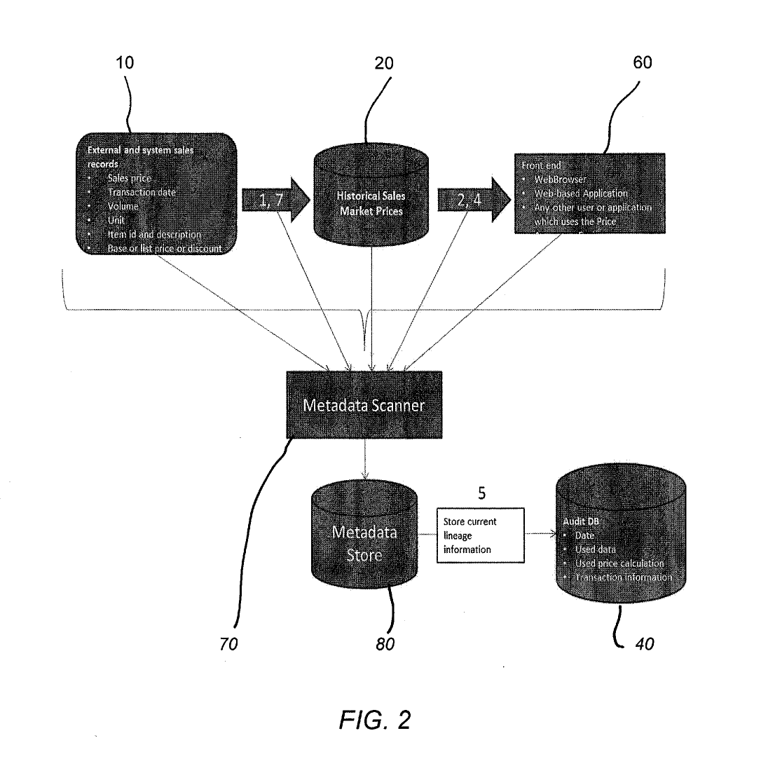

FIG. 2 shows a system and process flow diagram of a metadata scanning embodiment of the invention. In FIG. 2, it is shown that steps 1 and 7 (FIG. 1) are accessible to a metadata scanner 70 that compiles metadata into a metadata storage 80 such as a server or database or other storage connected to a computer or processor, by analyzing:
The structure of the records in the databases, e.g., the many databases of vendors 10 (thousands in a practical embodiment); and
The processes 1, 7, 2, and 4 of FIG. 1.

With each price calculation the process information (data lineage including the data structures, the used transformation and average algorithm) will be stored once in the audit database 40. In an embodiment of the invention, reference to this information will be provided with the executed order (FIG. 1). Further, with each price calculation the used data will be stored into the audit db 40, and a reference to this information will be provided with the price. For example, if an order is executed, the system will store the information about the order (date, price, amount, . . . ) in step 6 in FIG. 1 (step 5 in FIG. 2), as well as the reference about the used data and the lineage information into the audit database 40.

Further details concerning the algorithm being performed for price calculation are as follows.

The proposed system has access to a company or consortium's prior sales data, in the form of itemized sales records. Each such record identifies a variety of characteristics of the transaction. These characteristics included in a sales record, or which can be computed using the information in the record, typically include some or all of the following: item sold (by stock code or other identifier), class of item, quantity sold, total price, unit price, list price and/or manufacturer's price, discount allowed and/or markup over manufacturer's price, buyer identity (by name or by appropriate identification code), class of buyer (e.g. public sector, consumer, large business, etc.), sales channel, and sale location or region. However this list is not exhaustive.

The sales records can be made available to the price assurance engine in various ways: e.g., database tables, as ordinary files on a computer disk; or as directly communicated to the price assurance engine price assurance engine over a computer network connection (e.g., an intranet or internet). The sales data can be communicated at scheduled intervals (e.g. nightly or weekly), or in “real-time” as the sales actually occur, the invoices produced, or payment is received.

The system uses this data to compute average sale price(s) for the item. The averages can include or exclude specified prior sales or categories of prior sales, based on their characteristics.

For example, one might:
1. include or exclude sales to particular purchases or class or purchasers (e.g., include retail but exclude government sales);
2. exclude certain individual sales (e.g., all itemized sales from invoice #12345);
3. exclude sales from certain geographic territories, sales channels or class of customer;
4. exclude sales for fewer than a specified quantity; or
5. exclude prior sales by the customer making the price request.

This list is not exhaustive. In addition to entirely excluding certain sales data, the price assurance engine also can be configured to give certain sales less significance, or weight, in determining the averages. For example: sales between 6 and 12 months in the past might be given half the weight of sales less than 6 months in the past.

The system is designed to receive price requests that ask for a quotation for a specified quantity of a particular product for a specified customer, along with possibility other characteristics of the proposed transaction such as the sales channel, delivery conditions (place and time), etc. The price requests can arrive in batches (e.g., in a computer file), or one-by-one entered at a keyboard, over a network, from a web browser, or other media. The system responds by quoting the selected average price/unit, as well as an extended price for the total order if this is for more units, and a date or time stamp indicating when the quotation was produced and for long it will be honored.

As discussed below, many different averaging methods can be used by the price assurance engine and many common methods have additional configurable parameters. It would be expected that the average actually used could be subject to negotiation between the vendor and the customer for whom the quote is intended. The price assurance engine can maintain, for each product, many different averages computed according to a variety of rules. It can thus deliver the appropriate quote based on the identity of the requesting customer. The quotation can also depend on other characteristics of the transaction, such as the purchase quantity or delivery terms. The system can customize the quotation based on additional characteristics of the price request, for instance by excluding (or down-weighting) prior sales with dissimilar terms.

In a second version of the price assurance engine, instead of averaging the actual sale prices from prior transactions, the system instead averages sales discounts (including, potentially, mark-ups) as a percentage difference relative to some notional base price. The base price may be the manufacturers or vendor's “list price”, or else any internal book or cost price. In this version, the system can be provided with the discount (or markup) in the sales record. Alternatively, if the sales record contains the actual final sale price, the system will compute the imputed discount (or markup) using the actual sale price and the base price. If the system computes the imputed discount, it needs access to base prices categorized by item, date, and any other relevant factors. This base price information can be included in the sales record or kept in a separate database.

In this second version, when a price request is made, the price assurance engine will respond with the averaged discount, and/or will automatically apply the averaged discount to the item's list price and respond with a final price quotation. As in the first version, the method of averaging, and the prior sales data used in forming this average, can vary both with the customer and with other characteristics of the proposed transaction (e.g. such as purchase size, delivery terms, sales channel, etc.).

The difference between the two versions of the system might be clarified using the following example (where various columns, e.g. customer identity and item count, have been omitted):

| | Item# | | | | Unit-price | Base | |
|---|---|---|---|---|---|---|---|
| | (SKU) | Item Type | Date | . . . | for sale | price | Discount |
| 1 | 999 | Electronic | Jan. 1, 1999 | | $80 | $100 | 20% |
| 2 | 123456 | Electronic | Jan. 1, 1999 | | $186 | $200 | 7% |
| 3 | 999 | Electronic | Feb. 1, 1999 | | $120 | $150 | 20% |
| 4 | 999 | Electronic | Feb. 1, 1999 | | $142.50 | $150 | 5% |

In response to price request for item 999, version 1 of the system might report $114.17, being the average (80+120+142.50)/3. In contrast, a request to version 2 of the system for a price for item 999, on Feb. 1, 1999, might report $127.50. This would occur if it first computes the average discount for item 999, say (20+20+5)/3=15%, and then applies this to the prevailing base price ($150), to compute the final price of $127.50.

It is apparent that version 2 of the system may be desirable when the underlying (base) price of the item is changing frequently, since the discounts (or markups) for a product may exhibit more stability than the actual sales prices do. Another advantage of version 2 is that it is feasible to average discounts across multiple products. In the above example one might wish to use the average discount for all electronic goods rather than just for the particular item being requested. In that case we might compute an average discount of (20+7+20+5)/4=13%, giving a final quoted price for item 999 on Feb. 1, 1999 of $150−13%=$130.50. This possibility is particularly useful when some items have infrequent sales, or when new items are being introduced, because then more sales data is used to compute prices and so the averages will be more stable with time.

It is also useful when highly customized products are sold, so that there may be few if any prior sales of exactly the same goods for which we want a price quotation. Discounts can be averaged over an entire product line, or by product type, or by any other sales characteristics (e.g. averaging all sales of a particular size to compute an average volume discount).

Traditional pricing models typically use fixed discounts schedules (possibly varying by customer, class of customer, item, and/or class or item) in order to give certain customers favorable pricing, and to offer promotional pricing on certain items. In addition, traditional pricing models frequently include a variety of quantity discounts, and/or other discounts for special delivery or payment terms, etc. The price assurance engine is complementary to such traditional discount schemes. The average price reported by the system can be subject to further modifications (e.g. discounting) using traditional pricing schemes, if this is desired.

The averaging methods include weighting prior sales and

### Weighting Prior Sales

Usually, not all sales will be regarded as equally important. For instance, all else being equal, a sale of one unit should not influence the selected average as much as a sale of 100 units of the same product. Hence, it will be usual to associate a volume or quantity factor Qt with each transaction t. Qt is 0 if we wish to ignore a sale altogether; otherwise it measures how much weight we should attach to the sale. Some sensible choices to define Qt are:
1. Qt=number of units sold in the transaction t.
2. Qt=0 if the number of units sold in the transaction t is less than M, otherwise
3. Qt=1. Here M is a configurable threshold. This rule ignores all small sales transactions (less than M units).
4. Qt=number of units sold in sales transaction t, with a maximum of N. Here N is a configurable threshold. This weights sales by size up to some specified maximum weight, to avoid the average being overly dominated by a few unusually large sales.
5. Qt=0 if the number of units sold in the transaction t is greater than N. Here N is a configurable threshold. This rule ignores all large sales transaction (more than N units).

Similarly, not all sales even of the same size should be treated equally if they occur on different dates. A sale two years ago is perhaps less relevant than a similar sale yesterday, and in some cases, one might wish to ignore the former sale altogether. Thus we may also assign a date factor Dₜ with each transaction. Two common and useful rules for date factors are:
1. Dₜ=0 if the sale is older than time T, otherwise Dₜ=1. Here T is a configurable time period. For instance, if T=1 year, then all sales more than a year old are effectively ignored, and all sales within the last year are treated equally.
2. Dₜ=E^{age} where E is a configurable parameter between 0 and 1, and “age” is the time between the sale date and the current date (e.g., measured in days). This standard rule of exponentially decaying weighting treats older transactions as progressively less important, but in a more continuous way than if a sharp cutoff was used as in the prior rule. For example, if E=0.99 and we measure age in days, then a sale from 100 days ago would receive weight Dₜ=0.366 (relative to a sale today), because 0.99¹⁰⁰ is 0.366.

In addition to quantity or date, there may be other factors or characteristics that influence the weight we wish to attach to a particular transaction. However, it will be usual to combine the influence of all these factors, however determined, into a single weight Wₜ to each transaction. A common scheme will be to choose a quantity factor and date factor as above, and let the final weight Wₜ be the product of Dₜ×Qₜ, although other reasonable formulas can be found. Weights can be chosen on a scale so that larger weights have greater effect on the final average value, and that when Wₜ=0 then that transaction has no effect whatsoever. The price assurance engine also has the capability to exclude prior sales based on date, invoice number, or customer, delivery terms, sales channel, and so on. These characteristics may be also be used to change the weight attached to a sale.

### Rules for Combining Prices or Discounts

As previously noted, there are various existing formulas that provide appropriate definitions of average. Some of the most standard are mentioned here. In the following, let Pₜ be the actual value (either price or discount) of sales transactions t, and let Wₜ be the weight associated with the sale. In the case of price average, Pₜ will be the per-unit price of the transaction. In the case of discount averaging, Pₜ will be the percentage reduction from a known notional “list price” (increases from listed price can use a negative percentage). Let P be the computed “average” price (or discount) at some point in time. The following is a selection of standard, reasonable, schemes for computing P. In each scheme, we restrict attention only to sales of the item in question (or, in the case of discount averaging over product category—for a newly introduced product or service—e.g., over the class of items in question).
1. Median. In this method, P is the price such that on a weighted basis, exactly half the sales were at a price above P and half were below. That is, P is such that {Sum Wₜ for t such that Pₜ<P}=½ {Sum Wₜ for all t}.
2. N'th percentile. Here N is a configurable parameter, between 0 and 100. The N'th percentile is the price such that, on a weighted basis, N % of the sales were for less than this price and 100−N % were above this price. This generalizes the median (which corresponds to N=50) but allows one to define averages that are progressively more or less favorable to the purchaser as N is decreased or increased.
3. Mode. In this, P is the price that, on a weighted basis, was used most often.
4. Mean. In this P is the weighted arithmetic average, i.e., P={Sum Wₜ×Pₜ}/Sum {Wₜ}Example:

| | | | | | Unit- | | |
|---|---|---|---|---|---|---|---|
| | Item# | | | Quan- | price | Base | |
| | (SKU) | Item Type | Date | tity | for sale | price | Discount |
| 1 | 999 | Electronic | 1/1/99 | 1 | $80 | $100 | 20% |
| 2 | 123456 | Electronic | 1/1/99 | 10 | $186 | $200 | 7% |
| 3 | 999 | Electronic | 2/1/99 | 5 | $120 | $150 | 20% |
| 4 | 999 | Electronic | 2/1/99 | 12 | $142.50 | $150 | 5% |

Consider a price inquiry on Feb. 1, 1999 for 10 units of product 999 from a particular customer. Suppose that our agreement with this customer is that we will use the version 2 of the price assurance engine, averaging the discount, and using the “mean” definition of average. Furthermore, suppose that the agreement calls for us to weight by sales quantity, except to ignore altogether sales made for more than the requested quantity. Furthermore, we use an exponentially decaying weight scheme with E=0.99. Furthermore, we include sales for other products in the same product category, but weigh these half as much as sales of the actual product being requested. In this contrived example, W₄ is 0, because that sale was for too many units (12, but the current request is 10). W₃ is 5: Q₃ is 5 since the order was for 5 units, and W₃ is 1 since the sale is for today. W₂ is 10×0.732×½=3.66: Q₂ is 10, D₂ is 0.99³¹=0.732 since the sale is 31 days in the past, and there is an additional factor of ½ since the sale was not for the exact item. Finally, W₁ is simply 0.99³¹=0.732 since the sale was only for a single unit but was 31 days old. The final average discount is then (20×0.732+7×3.66+20×5+0×5)/(0.732+3.66+5)=14.93%.

All the averaging techniques given as examples above, with the exception of the N'th percentile method, attempt to compute “typical” prices or discounts biased neither towards unusually high or unusually low prices. As the N'th percentile method shows, however, this is not a necessary feature of the price assurance engine because many schemes exist that bias the quoted prices either higher or lower than is typical. For example, a very favored customer might negotiate to receive the 10^{th} percentile price (which, by definition, is lower than most other customers receive).

### Implementation Options

As described, the system computes various “average” prices or discounts in response to a price request. Different implementations of the system will compute these averages in a variety of ways.

In one style of implementation, the requested average price is computed entirely “on demand,” when a request is made. In this case, the system stores all relevant sales record that it has received until such time as a record will no longer be relevant to a request.

In any version of the system, the price assurance engine must include an interface for selecting which records are relevant to a query, and then for specifying which averaging technique to apply to the selected records. When the sales records are stored in a database, there exists an industry standard language for selecting a group of records, called SQL (Structured Query Language). One embodiment of the system defines an interface which is an extension of SQL. This extension will add averaging functions to the underlying SQL language, where the new functions are chosen to support the desired computation. The operator of the price assurance engine can then select and average the desired subset of records, in the desired fashion, by using a statement in the extended SQL language to select and average appropriately. Extensions to SQL of this nature, whereby new “aggregation” functions such as averages are added to the language, are commonplace in the industry. The innovation is the application of this idea to the process of price computation, and as a specific embodiment of the general price assurance engine.

In a second category of implementations, average prices are pre-computed and stored in anticipation of a corresponding price request. In this case, the system maintains a store of computed prices, on computed disk or in main memory.

In a third category of implementations, averages are maintained in an incremental fashion. In an incremental implementation of the price assurance engine, the system maintains compact summaries of the sales records seen so far, in such a fashion that the desired average(s) can be quickly computed using the summary. The summary is updated by each sales record as it enters the system. In this implementation, the system does not store the prior sales records themselves, but rather stores the more compact summary information. The appropriate summary or summaries differ depending on the specific definition of average used.

### EXAMPLE

Suppose we use the mean definition of average, and suppose for simplicity that each weight Wₜ is 1. If we maintain as two summaries a) the total price of all transactions (added together), and b) the total number of transactions, we can very quickly compute the average (mean) by dividing the former by the latter. However, when we see a new sales record, we can quickly update the summaries by adding the sales price to the former summary, and increasing the second summary by 1. In this way we avoid the need to store large volumes of information, while simultaneously being able to offer very fast, up-to-date, prices.

Incremental implementations will be fast and efficient. They are therefore suited to when the price assurance engine must operate with large volumes of data and/or is required to provide very fast, “real-time,” quotes. Real-time quotes, where the averages always include all sales up to the present time, are important when prices are volatile and up-to-date accuracy is important. (E.g. stock prices.)

One applications of the system is to E-commerce, where price requests are received through a web browser or otherwise by computer network, and where the quoted price is displayed on a web browser or is otherwise transmitted immediately of a computer network. See FIG. 1. In an E-commerce environment, transactions are proposed and considered far more quickly and with greater immediacy than traditional business dealings relying on slower communications technology. Hence this embodiment of the system will generally (but not invariably) use an incremental or “real-time” implementation of the price assurance engine.

Auditing and Customization

Prices provided by the system and method of the present invention are verifiable and auditable. As long as the contract, order, or individual transaction uses a specific price-calculation method, the pricing information (metadata) related to that method can be verified as accurate. Additionally, the chosen average may be recomputed based on underlying data or verified with statistical sampling techniques. Further, the system will automatically re-compute the price or discount, either in real-time or at a specified frequency (i.e., daily or monthly).

In this way, the system and method of the present invention leverages commercially available metadata-management software technology to greatly expand audit coverage and effectiveness, while significantly lowering auditing costs and reducing audit risk.

The system and method of the present invention has the capacity to maintain many different averages for each product or service. Because it can implement a variety of averaging methods, the system and method of the present invention is flexible enough to deliver appropriate quotes for every customer. While most methods are straightforward, others use additional parameters configured around specific needs, thresholds or business rules. An actual user would simply request that the vendor add parameters as they are needed or required.

### SUMMARY

The current difficulty interpreting pricing models, and the time it takes to manually conduct price negotiations and meet audit demands, means that price assurances are rarely, if ever, met. As a result, many large and small corporations forgo millions of dollars in sales revenue because of their inability to quickly and easily make sense of the tangle of buyer requirements. Using the system will confirm that the price paid for a commercial good or service is market-based, and that terms and conditions of the sale leverage volume-buying power, ensuring the best possible price and the best possible terms for all commercial transactions in today's marketplace.

What is claimed is:

1. A system of establishing and maintaining pricing for vendors providing products or services to buyers, comprising:
a first database maintained by at least one of a vendor and supplier storing current market prices of goods or services derived from external sources and executed sales;
a second database storing audit records;
a processor communicating with said first and second databases that executes pricing software to calculate prices of products or services and store the calculation results as audit records in said second database; and
at least one user terminal or computer of the user or buyer communicating with said processor,
wherein the processor calculates prices of products or services in response to the sending of a request through a user terminal such that information of a base price and a discount or final price is delivered to the user terminal and a user sends an executed order based on said price information to a vendor or supplier and information of said executed order is stored as an audit record in said second database.

2. A system of establishing and maintaining pricing for vendors providing products or services to buyers, comprising:
at least one first database storing current market prices of goods or services derived from external sources and from executed sales of a plurality of vendors;
a second database storing audit records;
a third database storing metadata; and
a metadata scanner including a processor communicating with said first and third databases that compiles metadata into the third database,
wherein the metadata scanner analyzes the records in the at least one database and calculates prices of products or services in response to the sending of a request through a user terminal such that information of a base price and a discount or final price is delivered to the user terminal and with each price calculation the price information and used data will be stored into the second database, and a reference to the data used will be stored with the price information, and
wherein a user sends an executed order based on said price information to a vendor or supplier to purchase a product or service.
